(19) United States
(12) Patent Application Publication
(10) Pub. No.: US 2013/0279967 A1
(43) Pub. Date: Oct. 24, 2013

(54) NOZZLE

(71) Applicant: Andreas OTTO, Kleinostheim (DE)

(72) Inventor: Andreas OTTO, Kleinostheim (DE)

(21) Appl. No.: 13/451,630

(22) Filed: Apr. 20, 2012

(51) Int. Cl. B43K 1/06

(52) U.S. Cl. 401/265

(57) ABSTRACT

The invention relates to a nozzle for paste-like masses with a housing which has an upper shell and a lower shell which delimit an inner space that broadens from an inlet opening in the direction of nozzle openings. To apply pasty-like material onto a surface reproducibly and in a desired pattern and quantity, the nozzle openings are delimited by a replaceable replacement insert arranged between the upper shell and the lower shell, and the nozzle openings are openable or closable by a closing element movable along the outer side of the upper or the lower shell.

The invention relates to a nozzle with a housing which consists of an upper shell and a lower shell which delimit an inner space that broadens from an inlet opening in the direction toward the nozzle openings.

To lay, for example, genuine wood flooring, linoleum or PVC floors, it is known to apply and distribute the adhesive required using a spatula. Here, the spatula may comprise notches on the margin to achieve a desired rib pattern, or to apply desired quantities of adhesive. Irregularities can also be compensated for. Persons who apply the adhesive in this manner have to do so in a bent over or kneeling position. It is also disadvantageous that an even distribution of the application quantity of the adhesive is not guaranteed, so that irregularities in the coating may result. Furthermore, the adhesive is not used optimally.

A nozzle of the type mentioned in the introduction for applying adhesive can be obtained from EP-A-1 447 142. Between the inner sides, and the lower and upper shells of a nozzle housing, spacer elements extend, which are used to guide the adhesive so it can exit evenly through all the nozzle openings.

The inflow direction and the discharge directions describe a right angle, so that a corresponding nozzle is operated disadvantageously in terms of energy. The nozzle openings themselves present a circular geometry.

A corresponding nozzle is also described in BE-A-1016978. Within the housing, several distribution elements extend, to even out the discharge of the fluid from the nozzle arrangements which are arranged in a row. The pasty material to be discharged takes place via a gun which is fed with the paste via a hydraulic press.

A device for applying a layer onto a fabric web can be obtained from WO-A-2004/014570. Here, the device comprises an exchangeable attachment, to be able to use discharge openings having different cross sections.

A device for surface application of viscous media is known from DE-A-103 20 813. To achieve different application patterns of the medium to be applied, replaceable nozzle ridges are provided.

A broad slit nozzle for coating with a thermoplastic coating material according to WO-A-2009/062460 comprises nozzle body parts which delimit a slit, and which are mutually adjustable to change the slit width.

To apply pastes, a nozzle is proposed according to JP-A-2008/253966 whose discharge channel can be closed.

The object of DE-A-10 2006 006 157 is a curtain application device for the application of pasty materials. Here, an application nozzle is used which consists of two half shells.

The present invention is based on the problem of modifying a nozzle of the type mentioned in the introduction so as to make it possible to apply a pasty material on a surface, in a reproducible manner and in a desired pattern and/or desired quantity, wherein simple construction measures are used to ensure that even if pasty material is located in the nozzle, and the nozzle is not in use, a hardening and thus a gumming up of the nozzle opening is prevented or largely prevented.

To solve the problem, the invention essentially provides that the nozzle openings are delimited by an exchangeable replacement insert arranged between the upper shell and the lower shell, and that the nozzle openings can be closed or opened by means of a closing element that can be shifted along the outer side of the upper shell or the outer side of the lower shell.

Based on the teaching according to the invention, simple construction measures make it possible to use nozzles of different cross sections, or to proceed to a replacement, in case of damage to the nozzle openings, by exchanging the replacement insert located between the lower and upper shells, and secured by means of the latter. Due to the fact that the replacement insert extends between the upper and lower shells, a reliable attachment is possible. It is only necessary to separate the upper and lower shells, to make the replacement insert accessible, and then replace it.

Furthermore, based on the teaching according to the invention, it is ensured that the pasty material in the nozzle openings does not harden in case of nonuse, and thus make a subsequent new use of the nozzle difficult or even impossible, without a cleaning taking place first; indeed, after the use of the nozzle, the openings of the closing element can be closed, so that a hardening is ruled out or reduced to an extent such that any hardened materials can be expelled without problem when the nozzle is operated again. Partial opening and/or closing of the nozzle openings is also covered by the invention.

Since the frequently highly viscous fluid is fed at a considerable pressure into the nozzle, it is provided in a variant of the invention that the lower shell and the upper shell transition into each other via a tongue-and-groove connection, i.e., that a kind of labyrinth seal extends between the upper and lower shells, preventing an outflow of fluid.

To prevent the discharge of fluid in the side area of the housing of the nozzle, it is provided particularly that the housing presents side surfaces whose respective width narrows conically in the direction of the nozzle openings, or which comprise in each case a conical guide, and that, along each one of the side surfaces and the marginal areas thereof—adapted to extend around, or along the respective conical guide—a sliding element connecting the upper and lower shells is movably arranged in each case. Thus, using simple construction measures, one ensures that the upper and lower shells are held together. At the same time, due to the conical course of the associated sections of the upper and lower shells, a problem-free removal can occur, i.e., the pulling of the sliding elements from the side surfaces.

The housing itself has, in a top view and a bottom view, a triangular shape, wherein, along the outer surface of the upper and lower shells, having in each case a triangular geometry, clamping plates extend, which can be connected via a clamping screw. In this way, the housing, i.e., the upper and lower shells, can be made of plastic, that is manufactured as an injection molded part, wherein, however, the required dimensional stability and strength are provided at the same time; indeed, by means of the clamping plates which are made of metal, and which extend with their surface along the lower and/or upper shells, at least in sections, the required stability is guaranteed. In addition to the sliding elements, a connection via a clamping screw thus occurs, which, starting from the upper shell, for example, is screwed into the clamping plate of the lower shell, or vice versa. Here, the clamping screw extends preferably in the central area of the respective outer surface of the upper and lower shells.

In order to be able to adjust the closing element that closes or opens the nozzle openings, in a simple manner, it is provided, in a variant of the invention, that the clamping plate extending along the upper shell comprises, on the nozzle opening side, a section that is at an angle and extends at a separation from the outer surface of the upper shell, wherein the sliding element extends between the outer surface and the clamping plate, in sections. Said sliding element is guided in the gap between the clamping plate and the outer surface.

To define, that is to delimit, the shifting, it is provided, furthermore, that the angled section comprises two elongated holes extending perpendicularly to the plane defined by the nozzle openings, or said elongated holes start from the section, and the are interspersed with means, such as a bracket-shaped handle or screw elements, starting from the preferably flat ridge-shaped shifting element. Thus, the length of the elongated holes determines the adjustment path of the sliding element, wherein an adaptation occurs in such a manner that the nozzle openings can be completely closed or completely opened. Other suitable measures for closing the nozzle openings are also possible.

In an inventive embodiment of the invention, it is provided that the spacer elements start from the inner side of the lower shell, and, when the upper and lower shells are assembled, are applied against the replacement insert, in sections, and against the inner surface of the upper shell, in sections. However, it is not beyond the scope of the invention, if the spacer elements start from the inner side of the upper shell, and are applied accordingly against the replacement insert attached by the lower shell, and against the inner surface of the lower shell. Due to these measures, an attachment of the replacement insert is made possible that is easy to carry out, while at the same time providing for a defined separation between the inner sides, and the upper and lower shells.

The replacement insert itself should comprise a ridge-shaped inner section, which is applied against a step of the inner side of the upper shell, which extends on the nozzle opening side, and, on the inner space-side, transitions into the inner surface of the upper shell, flush with said inner surface.

As a result, a definite attachment of the replacement insert is possible, i.e., in such a manner that, when a force is applied to the replacement insert from outside, no shifting into the interior cannot occur. Any tipping is also ruled out, since force is applied to the replacement insert via the spacer elements in the direction of the inner side of the upper shell. To prevent the replacement insert from coming out of the housing, it is provided, furthermore, that the inner section of the replacement insert presents recesses through which are interspersed with protrusions starting from the inner side of the upper shell or vice versa.

Moreover, it should be emphasized that the replacement insert comprises, extending on the nozzle opening side, an outer section which narrows in the form of a wedge in the direction of the openings of the nozzle, and which has first recesses extending in the longitudinal direction of the housing, which, when the upper and lower shells are assembled, in cross section delimit triangular, trapezoidal, rectangular, circular or circular segment-shaped nozzle openings, or nozzle openings that are oval in cross section or form segments of ovals.

Moreover, it is provided, that a central section extends between the inner and the outer section of the replacement insert, which section conically narrows, in cross section, starting from the outer section, in the direction of the inner section, and comprises second recess transitioning into the first recesses, wherein cross section of the second recess first increases, starting from the inner section, in the direction of the first recess, and then decreases until the cross section of the first recess to the transition in said recesses is reached, for the transition into said first recess. Here, in the maximum cross section of the second recesses, adjacent second recesses should present a mutual separation B where B≦1 mm.

Since the housing itself is made particularly of plastic, it is proposed, to prevent wear of the lower shell in the area of the nozzle openings, that a wear element, such as, a sheet metal element, particularly one made of spring steel, extends between the outer side of the lower shell, and the lower clamping plate, along the lower shell, up to the longitudinal margin thereof, which extends on the nozzle opening side.

Naturally, the lower clamping plate itself can be designed as a wear element, and extend up to the nozzle-side margin of the lower shell. To that extent, constructions pertaining to this should be considered to have the same effect. The same applies to the case where the wear element extends on the outside along the clamping plate.

In order to ensure a definite assignment of the clamping plates to the lower and upper shells, it is provided that the lower clamping plate is interspersed with first protrusions starting from the outer side of the lower shell, and the upper clamping plate with second protrusions starting from the outer side of the upper shell, wherein the cross section and/or geometric arrangement of the first protrusions deviate(s) from those or that of the second protrusions. A mechanical coding occurs.

The invention is characterized in that, when the upper and lower shells are assembled, the housing comprises a hollow cylinder section which surrounds the inlet opening and comprises an external thread, wherein the clamping ring can be screwed onto said section. Due to this measure, an additional positively locking connection of the upper and lower shells occurs, so that, even if a high pressurization of the fluid is ensured, no uncontrolled separation of the shells occurs. Here, it is provided particularly that the clamping ring comprises, on the inner side, a blade insert, to slit open pouches containing the pasty material to be delivered, when pressure is applied to them. This can occur by means of a gun, as can be seen, for example, in EP-A-0 254 969. Such a gun, i.e., the outlet opening thereof, can be connected via an adapter to the clamping ring.

The blade insert consists preferably of a ring element having a preferably triangular cutting edge extending eccentrically and perpendicularly with respect to the plane defined by the ring element. Here, the ring element can be attached by means of a snap ring which extends between the ring element and an inner ledge of the hollow cylinder against which the ring element is applied.

Additional details, advantages and characteristics of the invention result not only from the claims, from the characteristics to be obtained therefrom—individually and/or in combination—, but also from the following description of a preferred embodiment example that can be seen in the drawing.

The figures show:

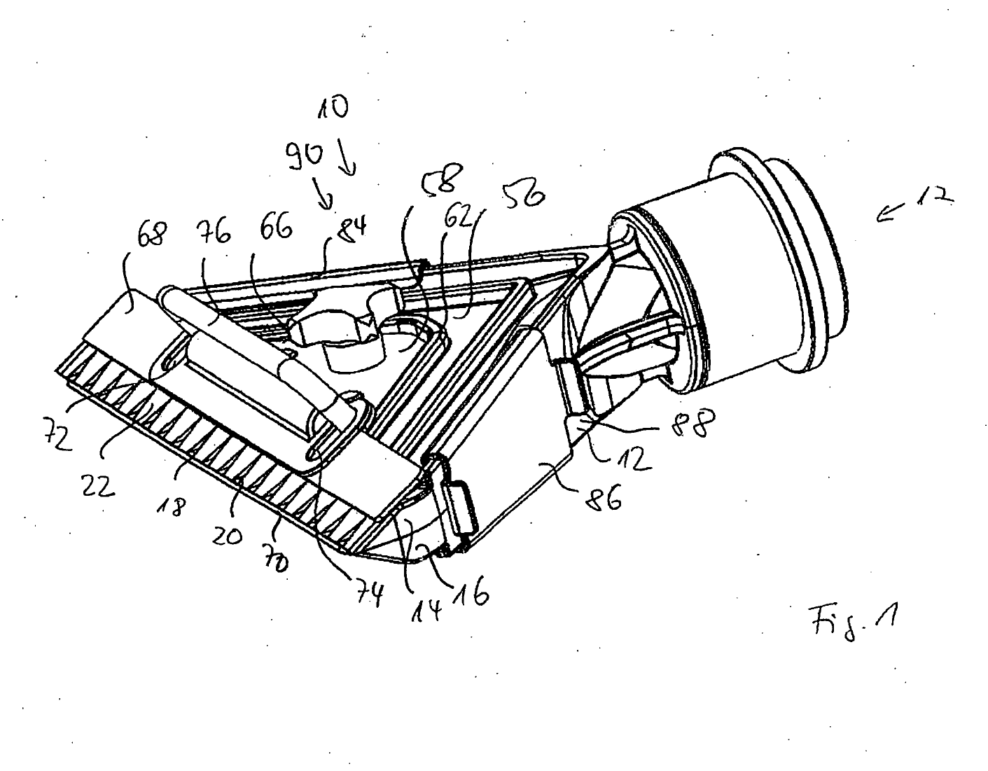

FIG. 1 a perspective view of a nozzle,

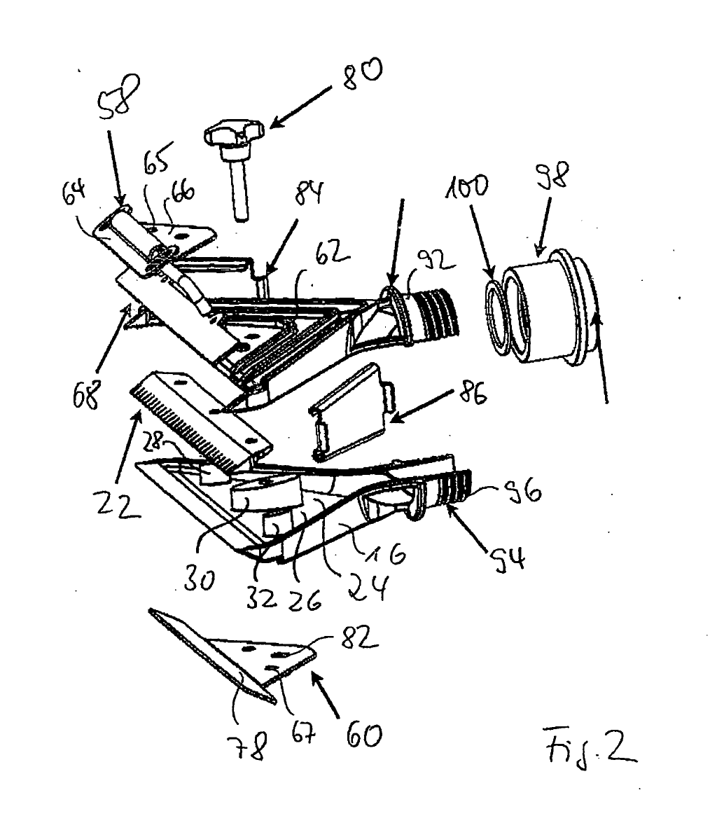

FIG. 2 the nozzle according to FIG. 1 in an exploded view,

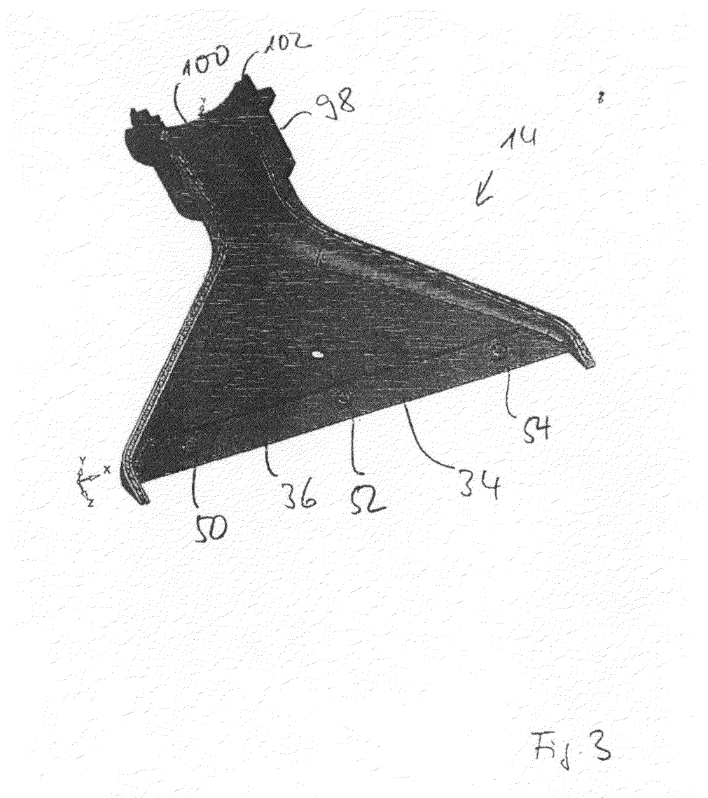

FIG. 3 the upper shell of the housing of the nozzle according to FIG. 1,

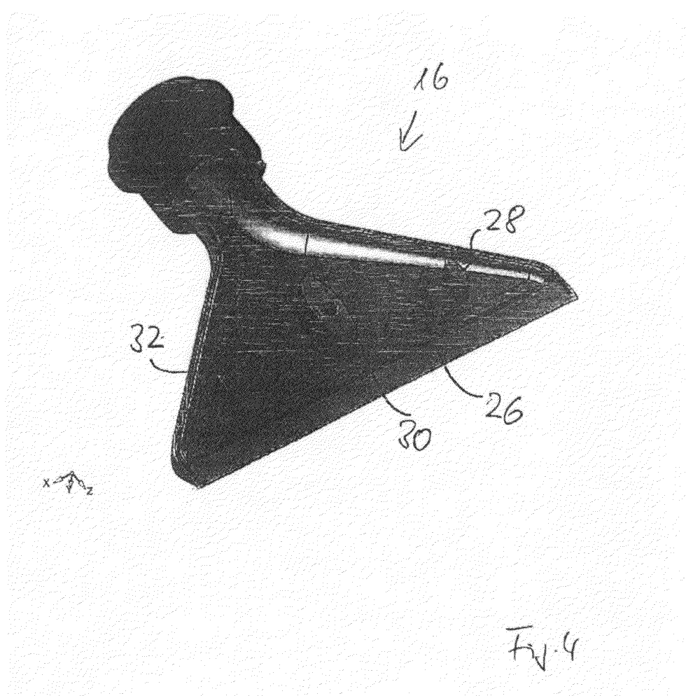

FIG. 4 the lower shell of the housing of the nozzle according to FIG. 1,

FIG. 5 the lower shell according to FIG. 4 with a replacement insert delimiting nozzle openings,

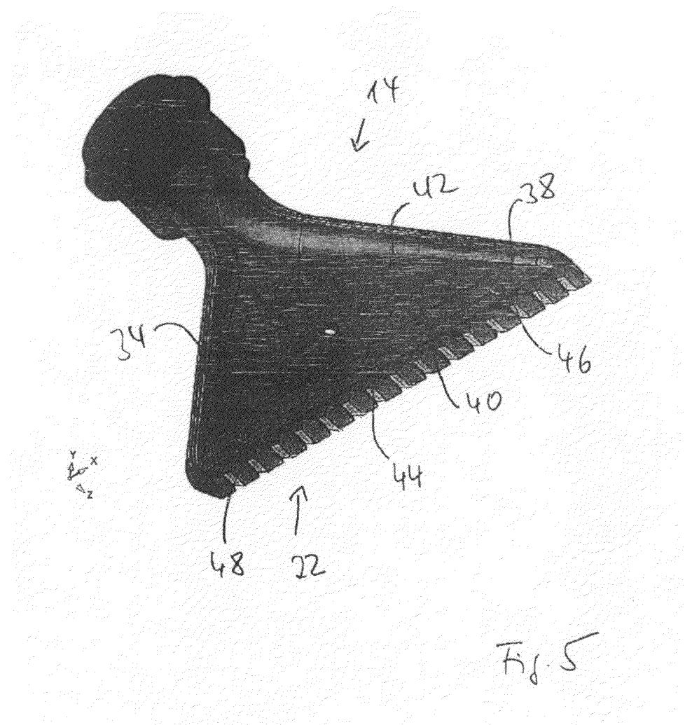

FIG. 6 a cross section through the nozzle according to FIG. 1 in the area of the holding-down devices,

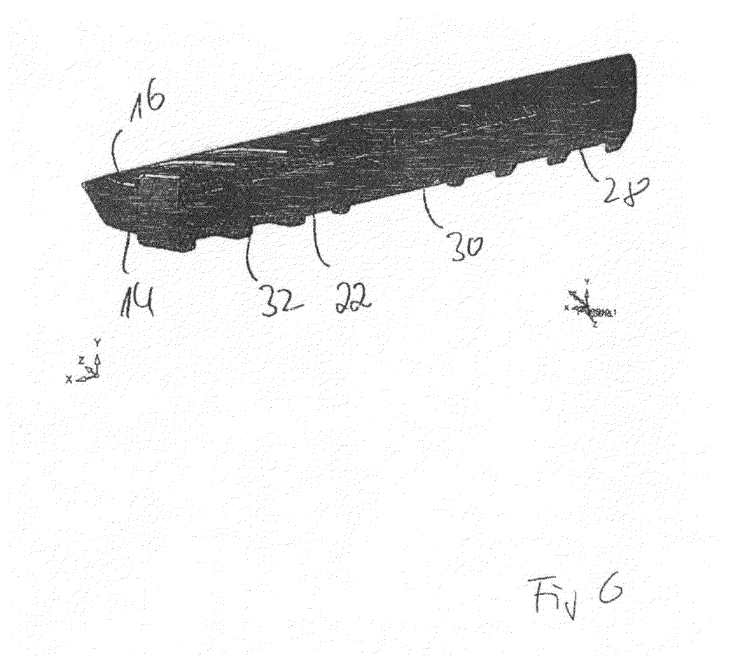

FIG. 7 a basic representation in a top view of a blade,

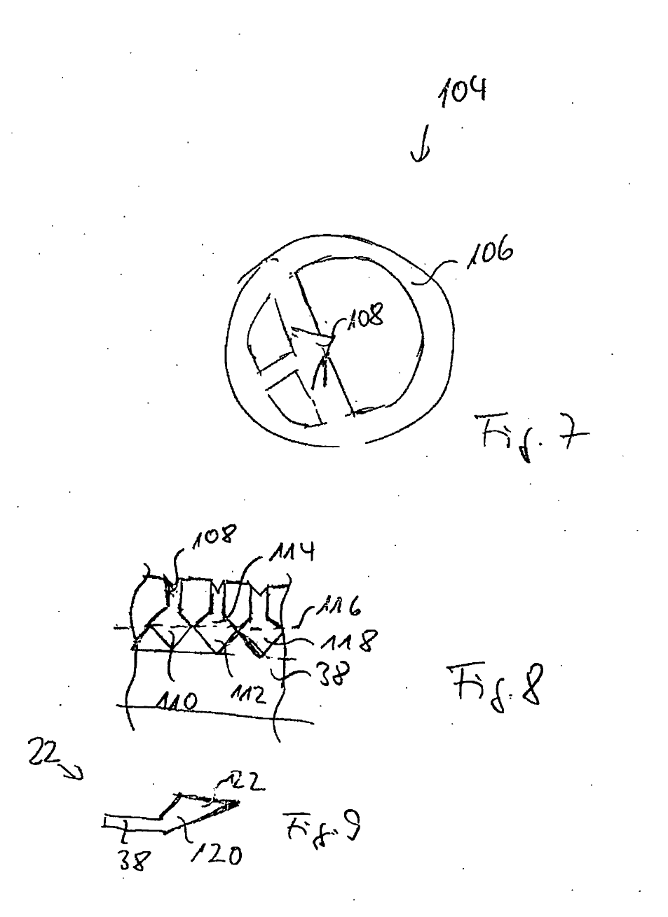

FIG. 8 a cut-out of a replacement insert in a top view, and

FIG. 9 a cross-sectional view of the replacement insert.

In the figures, in which the same reference numerals are in principle used for the same elements, a nozzle 10 for applying pastes is represented, wherein the materials can be low, medium or high viscosity materials, particularly adhesives, for the purpose of gluing, for example, genuine wood flooring, linoleum, PVC floors or artificial turf or the like.

For this purpose, the nozzle 10 to be referred to as a flat nozzle is used, which comprises a housing 12 that consists of an upper shell 14 and a lower shell 16. The latter lie on top of each other via a tongue-and-groove connection, as one can see in the drawn representations. As a result, a labyrinth seal is formed.

Starting from the inlet opening 17, the housing 12 broadens in the direction of nozzle openings extending along a straight line 16, two of which are marked as examples with the reference numerals 18, 20.

The nozzle openings 18, 20 are delimited by a replacement insert 22 as well as the upper shell 14 and the lower shell 16, as explained below.

Since the housing 12 broadens from the inlet opening 18 to the nozzle openings 18, 20, the housing 12 has a triangular geometry, in a top view and in a bottom view, as can be seen unmistakably in the drawn representations. Furthermore, the drawings show that the height of the inner space 24 delimited by the bottom and upper shells 14 decreases starting from the inlet opening 18, in the direction of the nozzle outlet openings 18, 20.

Spacer elements 28, 30, 32 start from the inner side 26 of the lower shell 16, and are arranged in the embodiment example in a row, while, however, deviating from each other in the longitudinal direction, in particular, due to the gap present, between the upper and lower shells 14, 16. Thus, the central spacer element 30 has a larger longitudinal extension in the longitudinal direction of the housing 12, and thus of the nozzle, than the spacer elements 28, 32 extending on the margin side. When the shells 14, 16 are assembled, the spacer elements 28, 30, 32 are applied against the inner side 34 of the upper shell 14.

In the end face area, the inner side 34 of the upper shell 14 presents a step 36, the height of which corresponds to the thickness of the replacement insert 22 with regard to its inner section 38, so that the inner-side surface 40 of the inner section 38 of the replacement insert 22 transitions into the inner surface 42 of the inner side 34 of the upper shell 14, flush with said inner surface.

From the drawn representation of FIG. 5, one can see moreover that the replacement insert 22 comprises recesses 44, 46, 48 which are interspersed with protrusions 50, 52, 54 starting from the inner side 34 of the upper shell 14, when the replacement insert 22 is inserted. Due to these measures, it is ensured that the replacement insert 22, when the housing 12 is closed, that is when the upper and lower shells 14, 16 lie on top of each other, cannot be pushed into the housing 12, or pulled or pushed out of the latter.

However, the spacer holders 28, 30, 32 do not have only the function of separating the lower and upper shells 14, 16 from each other, but also the function of holding-down devices, in particular for holding down the replacement insert 22.

As can be seen in the cross-sectional representation according to FIG. 6, the spacer holders 28, 30, 32—also called holding-down devices—starting from the lower shell 16 are applied not only against the inner surface 42 of the inner side 34 of the upper shell 14, but also, in sections, against the outer surface 14 of the inner section 38 of the replacement insert 22. Thus, a definite attachment of the replacement insert 22 and hence a tipping of the latter is ruled out.

In order to confer the required stability to the upper shell 14 and lower shell 16 made preferably of plastic and manufactured as an injection molded part, since the fluid to be applied is fed at high pressure into the inner space 24 through the nozzle openings 18, 20, clamping plates 58, 60 extend both along the outer side 56 of the upper shell 14 and also the outer side of the lower shell 16, clamping plates which extend in the central area of the upper side 56 of the upper and lower shells 14, 16, and are surrounded, in the embodiment example, in each case by a reinforcement rib 72.

As can be seen in the drawn representations, several corresponding reinforcement ribs, which are not marked in further detail, can be provided. The course of the reinforcement ribs 62 here corresponds approximately to the outer geometry of the upper or lower shell 14, 16, particularly seen in a top view.

The upper clamping plate 58 comprises a front section 64, which extends at a separation from a main section 66. Thus, a step is provided between them, wherein the main section 66 is applied by its surface on the top side 62 of the upper shell 14.

In the gap between the front section 64 of the clamping plate 58 and the top side 56 of the upper shell 14, a flat sheet metal-like closing element 68, which is designed as a flat metal sheet, and has a rectangular geometry in a top view, extends in sections, said closing element being movable along the top side 62 of the upper shell 14 in such a manner that, as desired, the nozzle openings 18, 20 can be closed or opened. In the representation of FIG. 1, the closing element 68 is retracted, so that the nozzle openings 18, 22 are open. If the nozzle 10 is not used, then the closing element 68 is adjusted in the direction of the front edge (longitudinal margin 70) of the housing 12 or of the lower shell 16, so that the openings 18, 20 are closed. Thus, a hardening of material located in the openings 18, 20 is prevented, or reduced to an extent such that the functional capacity of the nozzle 10 is not affected.

To allow a movement of the closing element 26 in the longitudinal direction of the nozzle 10, to open or close the nozzle opening 18, 20, the front angled section 64 of the clamping plate 58 presents elongated holes 72, 74, which extend in the longitudinal direction of the nozzle 10, and which are interspersed in the embodiment example with sections of the handle 76 which starts from the closing element 26. Alternative possibilities to be able to move the closing element 64 to the clamping plate 58, and thus to the upper shell 14, or to attach it to it, are also possible. Thus, from the closing element 64, screws with knurled nuts may start, which ensure the guidance in the elongated holes 72, 74 with simultaneously the possibility of attachment, to mention only one alternative as an example.

The lower clamping plate 60 can comprise, according to the drawn representation of FIG. 2, a front section 78 which extends to the end face 70 of the lower shell 16, and is used as wear protection. Alternatively, the possibility exists to attach a separate wear element via the closure plate 16, which wear element is made particularly of spring steel, and extends to the margin 70. Thus, it is ensured that the housing 12 or the lower shell 16 thereof, which is preferably made of plastic, is protected against wear.

When the bottom and upper shells 14, 16 are set on top of each other, that is after the tongue-and-groove connection has been established, a connection is made between the upper and lower shells by means of the clamping screw 80 which passes through the upper clamping plate 58, and which can be screwed into an internal thread 82 present in the lower clamping plate 60. Moreover, shifting elements 84, 86 are present, which are shifted on the side surfaces 88, 90 which narrow conically in the direction of the nozzle openings 18, 20, as shown in FIG. 1. Other possibilities to hold the lower and upper shells 14, 16 together, by means of correspondingly designed sliders 84, 86, also exist. Thus, the side surfaces 88 can present conically extending guiding grooves or ridges that work in cooperation with corresponding sliders.

On the inlet opening side, the upper and lower shells 14, 16 comprise hollow semicylindrical sections 92, 94, which form a hollow cylinder which comprises an external thread 96, when the shells 14, 16 are assembled. On the latter, a clamping sleeve—also called clamping ring 98—is screwed, so that the upper and lower shells 14, 16 are also held together on the opening inlet side by positive connection, and in the present case additionally by frictional connection.

As shown in FIG. 3, the clamping sleeve 98 is sealed with respect to the rear end face of the half shells 14, 16 via a seal 100 which comes to be applied against a peripheral inner projection of the clamping sleeve 98.

At a separation therefrom, the clamping sleeve 98 presents an undercut 102 into which a blade insert 104 can be inserted, which is secured on the outside by a snap ring—not shown—extending in the undercut 102. The blade insert 104 consists of a ring element 106 from which, eccentrically and approximately perpendicularly to the plane defined by the ring element 106, a cutting edge 108 which is triangular in cross section protrudes, to slit open a pouch which has been received by a cylinder—not shown—which can be connected to the clamping sleeve 98 by means of a coupling nut, pouch which contains the paste to be applied.

The nozzle openings 18, 20 may have any cross sections perpendicular to the fluid outlet direction. Preferred geometries are triangles, trapezes, rectangles, circles, circle segments, ovals or oval segments.

As can be seen in the detailed representation of FIG. 8, the replacement insert 22 which comprises the nozzle openings 18, 20 in its front area is designed in such a manner that the first recesses 108 start from the outer margin, recesses which, in the case of triangular outlet openings, have a triangular geometry in cross section. Said openings 108, referred to as first recesses, transition into the second openings or recesses 110, 118, which are connected to the inner space 24. The second sections 110 themselves consist of an inner first section 112 having a cross section which broadens conically starting with the ridge-shaped inner section 38, and then transition into a second section 114 which narrows conically, to reach a cross section corresponding to that of the first recess 108. In the area of the largest cross section of the second recesses 110, 118 (represented in the drawing by the line 116), the separation between the adjacent second recesses 108, 110 is smaller than 1 mm, particularly nearly point-shaped.

The geometry of the second recesses 110, 118, that is first the broadening of the cross section, and then the subsequent narrowing, also applies to other geometries besides the triangular cross-sectional geometry of the outlet openings 18, 20 shown in the drawing, that is of the first recesses 108.

Based on the teaching according to the invention, the nozzle 10 can be fitted with a desired replacement insert 22 to be able to use outlet openings 18, 20 of desired cross-sectional geometry. The replacement insert 22 is attached between the upper and lower shells 14, 16. Attachment elements accessible from outside are not needed.

FIG. 9 shows a cross section through the replacement insert 22. One can see the inner flat ridge-shaped section 38 adjacent to a central section 120 and an outer section 122.

The section 122 broadens starting from the inner section 38, and transitions into the outer section 122 which narrows towards the tip of the replacement insert 22. In the outer section 122, the first recesses 108 extends, which, delimited by the marginal areas of the lower and upper shells 14, 16, form the openings 18, 20. The second recesses 110, 118 extend in the central section 122.

The upper and lower clamping plates 58, 60 present recesses 65, 67, for example, as marked in the drawing, into which the correspondingly arranged protrusions starting from the top sides 62 of the upper and lower shells 14, 16 engage. Here, the geometric arrangement of the protrusions, and thus of the recesses 65, 66 of the upper and lower shells 14, 16 mutually deviate to provide a mechanical coding. Thus, confusion between the clamping plates 58, 60 is not possible, rather a definite assignment to the upper shell 14 and to the lower shell 16 is guaranteed.

1. Nozzle (10) for pastes, having a housing (12) which consists of an upper shell (14) and a lower shell (16) which delimit an inner space (24) that broadens from an inlet opening (17) in the direction of the nozzle openings (18, 20),
characterized in that
the nozzle openings (18, 20) are delimited by a replaceable replacement insert (22) arranged between the upper shell (14) and the lower shell (16), and in that the nozzle openings are closeable or openable in a closing element (68) that can be moved along the outer side of the upper or the lower shell.

2. Nozzle according to claim 1,
characterized in that
the lower shell (16) and the upper shell (14) transition into each other via a tongue and groove connection.

3. Nozzle according to claim 1,
characterized in that
the housing (12) comprises side surfaces (88, 90) the width of which narrows conically in the direction of the nozzle openings (18, 20), or which in each case present a conical guide, and in that, along the side surface and enclosing the latter in the marginal area, or along the conical guides, a sliding element (84, 86) is movably arranged in each case, connecting the upper and lower shells (14, 16).

4. Nozzle according to claim 1,
characterized in that
the housing (12) has a triangular shape in a top and a bottom view, and in that, along the respective outer surface of the upper and lower shells (14, 16), which has a triangular geometry, clamping plates (58, 60) extend, which are connectable via a clamping screw (80).

5. Nozzle according to claim 1,
characterized in that
the clamping plate extending along the upper shell (14) comprises on the nozzle opening side a section (64) which extends at an angle, and at a separation with respect to the outer surface (56) of the upper shell, wherein the sliding element (68) extends in sections between the outer surface and the clamping plate.

6. Nozzle according to claim 5,
characterized in that
the angled section (64) comprises two elongated holes (72, 74) extending perpendicularly to the plane defined by the nozzle openings (18, 20), or start from the section, which are interspersed with means, such as, bracket-shaped handle (76) or screw elements, starting from the preferably flat ridge-shaped sliding element (68).

7. Nozzle according to claim 1,
characterized in that
spacer elements (28, 30, 32) start from the inner side of the lower shell (16), which spacer elements, when the upper and lower shells (14, 16), are assembled, are applied in sections against the replacement insert (22) and in sections against the inner surface (34) of the upper shell.

8. Nozzle according to claim 1,
characterized in that
the replacement insert (22) comprises a ledge-shaped inner section (38), which is applied against a step (36) of the inner side of the upper shell (14), which step extends on the nozzle opening side, and transitions on the inner space side into the inner surface (34) of the
upper shell, flush with said inner surface.

9. Nozzle according to claim 8,
characterized in that
the inner section (38) of the replacement insert (22) comprises recesses (44, 46, 48) which are interspersed with protrusions (50, 52, 54) which start from the inner side (34) of the upper shell (14) or vice versa.

10. Nozzle according to claim 1,
characterized in that
the replacement insert (22) comprises, extending on the nozzle opening side, an outer section (122) which narrows in the shape of a wedge in the direction of the openings of the nozzle, having first recesses (108) which extend in the longitudinal direction of the housing, and which, when the upper and lower shells are assembled, delimit in cross section triangular, trapezoidal, rectangular, circular or circle segment-shaped nozzle openings (18, 20), or nozzle openings forming in cross section ovals or segments of ovals.

11. Nozzle according to claim 10,
characterized in that,
between the inner and the outer sections (38, 122) of the replacement insert (22), a central section (120) extends, which narrows conically in cross section starting from the outer section in the direction of the inner section, and comprises second recesses (110, 118) that transition into the first recesses, wherein the cross section of the second recess first increases starting from the inner section, in the direction of the first recess, and then decreases until the cross section of the first recess is reached, for the transition into said cross section.

12. Nozzle according to claim 11,
characterized in that,
in the area (116) of maximum cross section of the second recesses (110, 118), adjacent second recesses have a mutual separation B where B≦1 mm.

13. Nozzle according to claim 4,
characterized in that,
between the outer side of the lower shell (16) and the lower clamping plate (60), a wear element, such as, a sheet metal element, particularly one made of spring steel, extends, along the lower shell up to the longitudinal margin (70) thereof, which extends on the nozzle opening side.

14. Nozzle according to claim 4,
characterized in that
recesses (67) of the lower clamping plate (60) are interspersed with first protrusions starting from the outer side of the lower shell (16), and recesses (67) of the upper clamping plate (58) by second protrusions starting from the outer side (56) of the upper shell (14), wherein the cross section and/or geometric arrangement of the first protrusions deviate(s) from those or that of the second protrusions.

15. Nozzle according to claim 1,
characterized in that,
when the upper and lower shells (14, 16) are assembled, the housing (12) comprises a hollow cylinder section (92, 94) which surrounds the inlet opening (17) and comprises an outer thread (96), on which hollow cylinder section a clamping ring (98) can be screwed, wherein the clamping ring preferably comprises on the inner side a blade insert (104) for cutting a pouch containing the paste, wherein the blade insert (104) preferably consists of a ring element (106), and, eccentrically with respect to said ring element, of a preferably triangular cutting edge (108) extending perpendicularly to the plane defined by the ring element, and wherein the ring element (106) is applied particularly against an inner peripheral ledge of the clamping ring (98), and secured by means of a snap ring.
